(19) United States
(12) Patent Application Publication
(10) Pub. No.: US 2016/0190800 A1
(43) Pub. Date: Jun. 30, 2016

(54) Electrostatic Discharge Protection Apparatus

(71) Applicant: Texas Instruments Incorporated, Dallas, TX (US)

(72) Inventors: Cynthia Torres, Austin, TX (US); Jairo Olivares, Dallas, TX (US); Prasad Gaitonde, Irving, TX (US)

(21) Appl. No.: 14/587,940

(22) Filed: Dec. 31, 2014

(51) Int. Cl. H02H 9/04

(52) U.S. Cl. CPC H02H 9/04

(57) ABSTRACT

An electrostatic discharge (ESD)-triggered protection apparatus includes an ESD trigger circuit having a set of diodes coupled to a resistor. An ESD discharge device is coupled to the ESD trigger circuit. Further, a pre-driver circuit coupled between the ESD trigger circuit and the ESD discharge device.

### TECHNICAL FIELD

Embodiments of the disclosure relate to semiconductor integrated circuits to protect such circuits from electrostatic discharge (ESD).

### BACKGROUND

Semiconductor integrated circuits utilizing high impedance transistor technologies such as metal oxide semiconductor (MOS) technologies are known to be vulnerable to ESD. ESD “events” may include the so-called “human body model” (HBM) type of event. See e.g., JEDEC Standard JS-001-2012, JOINT JEDEC/ESDA STANDARD FOR ELECTROSTATIC DISCHARGE SENSITIVITY TEST—HUMAN BODY MODEL (HBM)—COMPONENT LEVEL (2012) for additional information about HBM. A person may accumulate static electrical charge on the surface of his or her body, generally through the rubbing together of dissimilar articles of clothing, shoes rubbing against carpet, clothing rubbing against a car seat when entering or exiting a vehicle, etc., particularly at times of low relative humidity. An HBM ESD event occurs when the person subsequently touches a conductor, including perhaps an electronic circuit and discharges the accumulated charge to and through circuit components. Such components may be subject to damage by a resulting discharge pulse of 1000 volts or more with a discharge time of several hundred nanoseconds.

The ESD protection circuits include a trigger circuit having a resistor and a capacitor to sense an ESD strike. Such ESD RC trigger circuit (or ESD clamp) turns on falsely during fast power rise. This induces self-damage, or damage elsewhere in the circuitry. The system on chips (SoCs) with fast power rise have to either add board components, which add costs, or limit power rise to solve this problem. One way to solve this problem is to use RC (resistor capacitor) trigger with desensitized RC. This clamp desensitizes RC trigger to improve clamp response, but clamp still leaks current. Existing ESD clamps employ RC transient triggers, which work on the ESD rise edge. Problem occurs with fast rising power and when the clamp produces leakage current.

### SUMMARY

Various aspects of the disclosure provides electrostatic discharge (ESD)-triggered protection apparatus having an ESD trigger circuit including a set of diodes coupled to a resistor. The set of diodes is configured to be forward biased in response to a threshold level of the ESD pulse. An ESD discharge device is coupled to the ESD trigger circuit. Further, a pre-driver circuit coupled between the ESD trigger circuit and the ESD discharge device.

Other aspects and example embodiments are provided in the Drawings and the Detailed Description that follows.

### BRIEF DESCRIPTION OF THE VIEWS OF DRAWINGS

FIG. 1 is a block diagram of an ESD-triggered protection apparatus according to various embodiments;

FIG. 2 depicts a circuit level implementation of the ESD protection apparatus of FIG. 1;

FIG. 3 depicts the ESD protection apparatus where the power rail is supplied by a battery; and

FIGS. 4, 5 and 6 are a series of plots associated with the ESD protection apparatus showing improvement in circuit response during a fast rising power according to various example embodiments.

### DETAILED DESCRIPTION OF THE EMBODIMENTS

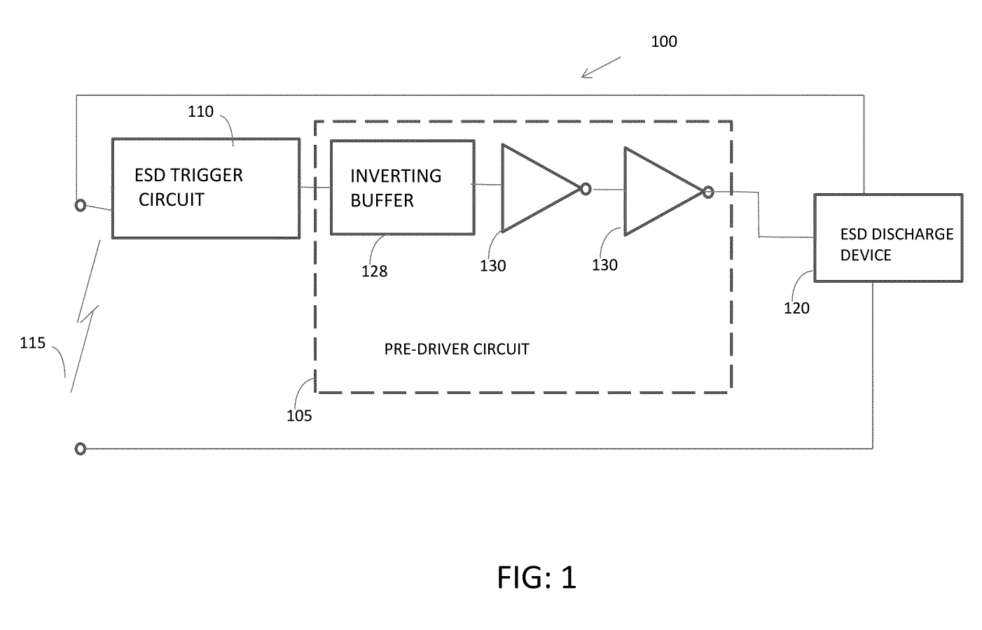

FIG. 1 is a block diagram of an ESD-triggered protection apparatus 100 according to various embodiments. The ESD-triggered protection apparatus 100 includes an ESD trigger circuit 110. The ESD trigger circuit 110 includes a set of diodes coupled to a resistor, to sense an ESD pulse and to generate a switching pulse responsive to the ESD pulse. The ESD trigger circuit 110 senses an ESD pulse 115 and generate a switching pulse responsive to the ESD pulse 115. The ESD trigger circuit 110 is configured for a specific application by setting the threshold level of the ESD pulse to a required value. The set of diodes is configured to be forward biased in response to a threshold level of the ESD pulse 115. The switching pulse cascades through the protection apparatus 100 as further described below. In one embodiment, the switching pulse is configured to be programmable by tuning the set of diodes.

The ESD protection apparatus 100 also includes an ESD discharge device 120 communicatively coupled to the ESD trigger circuit 110. The ESD discharge device 120 operates in response to the switching pulse to transfer a current generated by the ESD pulse 115 to a ground rail 125. The protection apparatus 100 also includes a pre-driver circuit 105 having an inverting buffer 128 and a set of inverters 130 communicatively coupled between the ESD trigger circuit 110 and the ESD discharge device 120. The pre-driver circuit 105 propagates the switching pulse from the ESD trigger circuit 110 to the ESD discharge device 120.

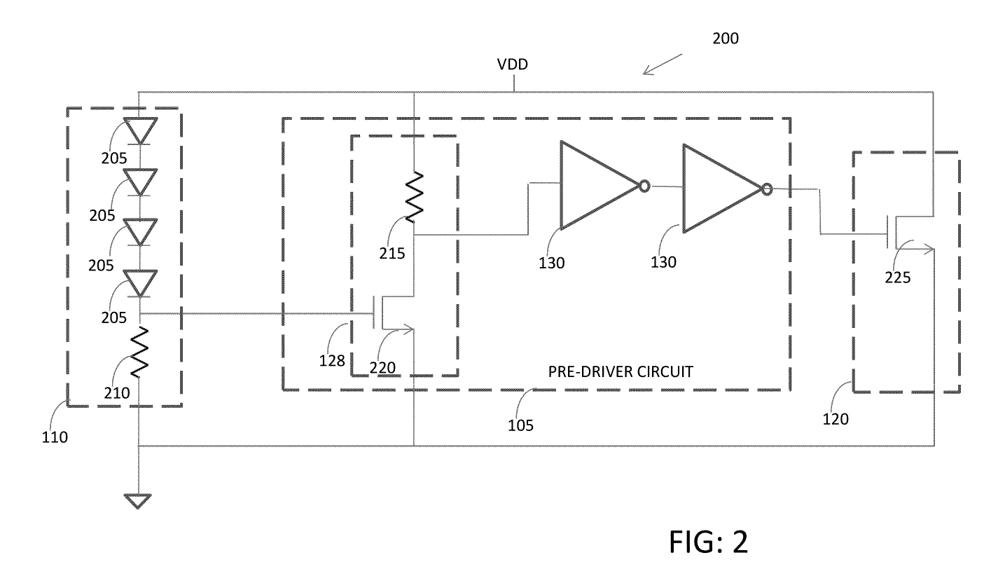

Referring now to FIG. 2, a circuit level implementation of the ESD protection apparatus of FIG. 1 is depicted. The ESD protection apparatus 200 includes the ESD trigger circuit 210 having a set of diodes 205 coupled to a resistor 210. The set of diodes 205 is coupled to a VDD voltage rail and the resistor 210 is coupled to the set of diodes 205 and to a ground rail. The switching pulse is generated at a node between the set of diodes 205 and the resistor 210. The ESD trigger circuit 110 is coupled to the pre-driver circuit 105. The pre-driver circuit 105 includes an inverting buffer 128 coupled to a set of inverters 130. The inverting buffer 128 has a resistor 215 coupled to a VDD voltage rail and a PMOS transistor 220 coupled to the ground and the ESD trigger circuit 110 is coupled to the PMOS transistor 220. Each of the set of inverters 130 includes a PMOS transistor coupled to the VDD voltage rail 215. Each inverting buffer 130 also includes an NMOS transistor coupled to ground rail (PMOS and NMOS transistors not shown in figures). It is noted that NMOS transistor associated with the last inverter of the set of inverters 130 is fabricated with a long, narrow-width channel to provide resistance characteristics. It is also noted that some embodiments include additional or fewer inverting buffers and that each inverting buffer may be structured with additional or fewer transistors and/or other components.

The pre-driver circuit 105 is coupled to the ESD discharge device 120. The ESD discharge device 120 includes a power MO SFET transistor 120 having a conduction channel with a width sufficient to transfer the current generated by the ESD pulse 115 to ground rail. Although reference is made in this disclosure to the power MOSFET transistor 230 as the ESD discharge device 120, it is noted that other implementations of the ESD discharge device 120 are contemplated herein.

As such, the ESD trigger circuit 110 is designed to initiate a switching cascade through the protection apparatus 200 in order to cause the ESD discharge device 120 to begin dissipating energy associated with the ESD pulse 115. The ESD trigger circuit 110 is implemented as a voltage level based trigger, meaning, the set of diodes 205 are configured to be forward biased in response to a threshold level of the ESD pulse 115. During fast power rise, an RC based ESD trigger gives a false trigger. Since, the ESD trigger circuit 110 is implemented with the set of diodes, the diodes are forward biased only at a threshold level of the ESD pulse 115, and thus avoiding the false triggering problem associated with RC based ESD trigger circuits. The occurrence of an ESD event resulting in an ESD pulse 115 causes a large initial voltage drop across trigger circuit resistor 210. The voltage drop across trigger circuit resistor 210 forward biases PMOS transistor 220, resulting in a positive pulse at the output. This positive pulse is then propagated through the inverters 130 to forward bias the ESD discharge device (power MOSFET transistor 225). The power MOSFET transistor 225 opens a low resistance, high current capacity channel through which to discharge the energy produced by the ESD pulse 115.

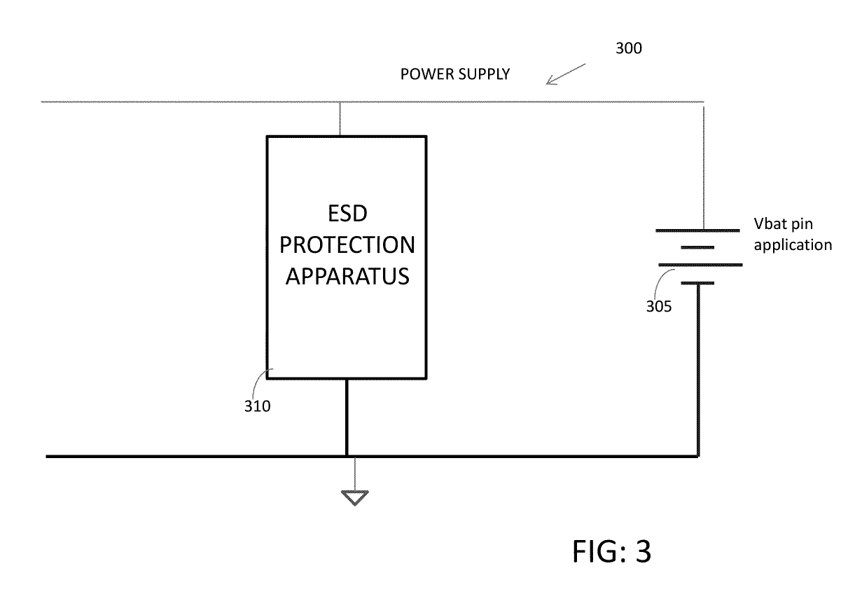

FIG. 3 depicts the ESD protection apparatus 300 where the power rail is supplied by a battery 305. The ESD protection apparatus 300 is same as the ESD protection apparatus 200 in connection and operation and is not explained again for brevity of the description. The ESD protection apparatus 300 is configured to work in certain scenarios including “hot swapping” the battery (plugging in the battery suddenly while the system is on). This leads to a very fast ramp of the power supply and can lead to false triggering of ESD trigger circuit 110 and damaging circuitry due to too much current. Various embodiments of the disclosure will prevent this type of scenario from causing damage by keeping the ESD trigger circuit 110 off even during very fast power ramp rates.

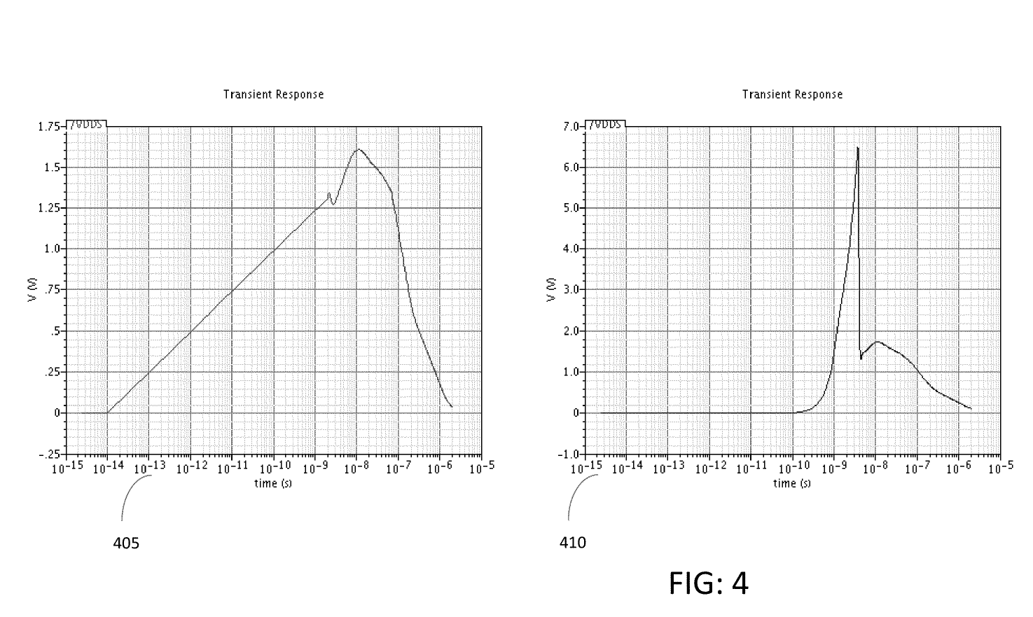

FIGS. 4, 5 and 6 are a series of plots associated with the ESD protection apparatus 200 showing improvement in circuit response during a fast rising power according to various example embodiments. Referring now to FIG. 4, plot 405 depicts response of a conventional RC ESD trigger circuit and plot 410 depicts that of the ESD protection apparatus 200. A modeled 2 kV HBM event was introduced to both circuits 405 and 410. The RC clamp ESD trigger circuit 405 shows the ESD clamp triggering at around 1.6V, while the ESD protection apparatus 410 shows a level trigger of about 6.5V. It is noted form the figure that the ESD trigger circuit 110 is not turned on until a certain voltage level is exceeded (in this case 6.5V).

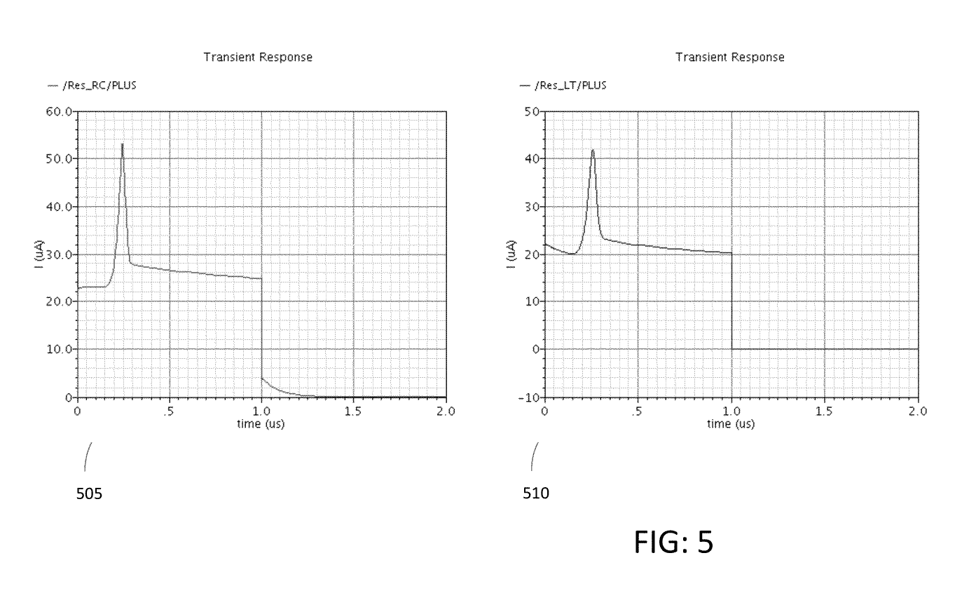

Referring now to FIG. 5, simulation comparison between the conventional RC ESD trigger circuit 505 and the ESD protection apparatus 200 (510) with 1 μs power rise is depicted. Different power supply ramps were tested on both circuits and the leakage current through the ESD discharge device 120 was measured. With a 1 μs power ramp, both circuits do not engage and only low amounts of leakage current (20-30 uA) are detected.

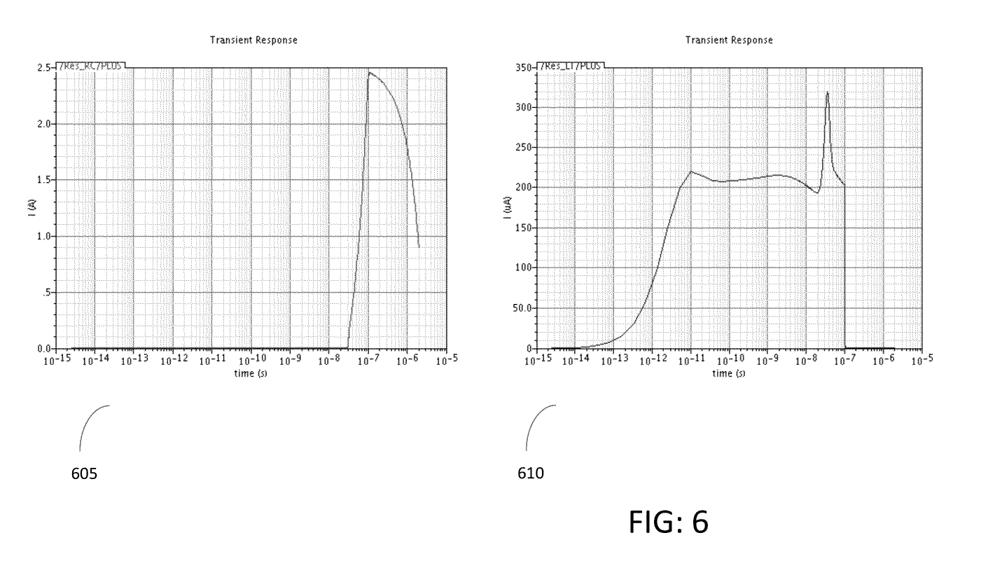

Referring now to FIG. 6, simulation comparison with 100 ns power rise between the conventional RC ESD trigger circuit 605 and the ESD protection apparatus 200 (610) with 1 μs power rise is depicted. A power ramp of 100 ns was applied to both circuits, and the leakage of the ESD discharge device 120 was observed. The plots show that the RC clamp (605) fully triggers and up to 2.5 A can be observed, while the ESD trigger circuit 110 is limiting the leakage to 2-300 μA since the designed trigger voltage of 6V was not met. This simulation clearly shows that the ESD trigger circuit 110 is off during fast power ramps as opposed to the conventional RC ESD trigger circuit.

It is noted that the ESD protection apparatus according to various embodiments can be employed in a variety of electronic devices such as microprocessors, application specific integrated circuits (ASICs), microcontrollers, and systems on chip (SoC). Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., MP3 (Motion Picture Experts Group, Audio Layer 3) players), vehicles, medical devices (e.g., heart monitor, blood pressure monitor, etc.), set top boxes, and others.

The forgoing description sets forth numerous specific details to convey a thorough understanding of the invention. However, it will be apparent to one skilled in the art that the invention may be practiced without these specific details. Well-known features are sometimes not described in detail in order to avoid obscuring the invention. Other variations and embodiments are possible in light of above teachings, and it is thus intended that the scope of invention not be limited by this Detailed Description, but only by the following Claims.

What is claimed is:

1. An electrostatic discharge (ESD)-triggered protection apparatus, comprising:
an ESD trigger circuit including a set of diodes coupled to a resistor;
an ESD discharge device coupled to the ESD trigger circuit; and
a pre-driver circuit coupled between the ESD trigger circuit and the ESD discharge device.

2. The ESD-triggered protection apparatus of claim 1, wherein the ESD trigger circuit is configured to sense an ESD pulse and to generate a switching pulse responsive to the ESD pulse.

3. The ESD-triggered protection apparatus of claim 1, wherein the set of diodes is configured to be forward biased in response to the ESD pulse at a threshold level, and wherein the set of diodes are connected in series.

4. The ESD-triggered protection apparatus of claim 1, wherein the switching pulse is configured to be programmable by tuning the set of diodes.

5. The ESD-triggered protection apparatus of claim 1, wherein the ESD trigger circuit is configured for a specific application by setting the threshold level of the ESD pulse to a required value.

6. The ESD-triggered protection apparatus of claim 1, wherein the ESD discharge device comprises:
a power metal oxide semiconductor field effect transistor (MOSFET) having a current channel width sufficient to transfer a current generated by the ESD pulse to ground.

7. The ESD-triggered protection apparatus of claim 1, wherein the ESD trigger circuit further comprises:
the set of diodes coupled to a VDD voltage rail; and
the resistor coupled to the set of diodes and to a ground rail, the switching pulse to originate at a junction of the resistor and the set of diodes responsive to the ESD pulse.

8. The ESD-triggered protection apparatus of claim 1, wherein the pre-driver circuit comprises:
an inverting buffer coupled to a set of inverters to propagate the switching pulse from the ESD trigger circuit to the ESD discharge device.

9. The ESD-triggered protection apparatus of claim 1, wherein the inverting buffer comprises a resistor coupled to a VDD voltage rail and a PMOS transistor coupled to the ground, the ESD trigger circuit coupled to the PMOS transistor.

10. The ESD-triggered protection apparatus of claim 8, wherein each inverter of the set of inverters includes a PMOS transistor coupled to a VDD voltage rail and an NMOS transistor coupled to ground.

11. An electrostatic discharge (ESD)-triggered protection apparatus, comprising:
an ESD trigger circuit, including a set of diodes coupled to a resistor, to sense an ESD pulse and to generate a switching pulse responsive to the ESD pulse, the set of diodes configured to be forward biased in response to a threshold level of the ESD pulse;
an ESD discharge device coupled to the ESD trigger circuit and responsive to the switching pulse to transfer a current generated by the ESD pulse to ground; and
a pre-driver circuit coupled between the ESD trigger circuit and the ESD discharge device to propagate the switching pulse from the ESD trigger circuit to the ESD discharge device.

12. The ESD-triggered protection apparatus of claim 11, wherein the switching pulse is configured to be programmable by tuning the set of diodes, and wherein the switching pulse is dependent on a number of diodes in the set of diodes.

13. The ESD-triggered protection apparatus of claim 11, wherein the set of diodes are connected in series.

14. The ESD-triggered protection apparatus of claim 11, wherein the ESD trigger circuit is configured for a specific application by setting the threshold level of the ESD pulse to a required value.

15. The ESD-triggered protection apparatus of claim 11, wherein the ESD trigger circuit is configured to generate the switching pulse in response to the ESD pulse at a threshold level during a fast power rise of the ESD pulse.

16. A device comprising:
a battery; and
an electrostatic discharge (ESD)-triggered protection apparatus coupled to the battery, the ESD triggered protection apparatus including:
an ESD trigger circuit, including a set of diodes coupled to a resistor, to sense an ESD pulse and to generate a switching pulse responsive to the ESD pulse, the set of diodes configured to be forward biased in response to the ESD pulse at a threshold level;
an ESD discharge device coupled to the ESD trigger circuit and responsive to the switching pulse to transfer a current generated by the ESD pulse to ground; and
a pre-driver circuit coupled between the ESD trigger circuit and the ESD discharge device to propagate the switching pulse from the ESD trigger circuit to the ESD discharge device.

17. The ESD-triggered protection apparatus of claim 16, wherein the switching pulse is configured to be programmable by tuning the set of diodes, and wherein the switching pulse is dependent on a number of diodes in the set of diodes.

18. The ESD-triggered protection apparatus of claim 16, wherein the set of diodes are connected in series.

19. The ESD-triggered protection apparatus of claim 16, wherein the ESD trigger circuit is configured for a specific application by setting the threshold level of the ESD pulse to a required value.

20. The ESD-triggered protection apparatus of claim 16, wherein the ESD trigger circuit is configured to generate the switching pulse in response to the ESD pulse at a threshold level during a fast power rise of the ESD pulse.
